(19) United States
(12) Patent Application Publication
(10) Pub. No.: US 2014/0257808 A1
(43) Pub. Date: Sep. 11, 2014

(54) APPARATUS AND METHOD FOR REQUESTING A TERMINAL TO PERFORM AN ACTION ACCORDING TO AN AUDIO COMMAND

(71) Applicant: SAMSUNG ELECTRONICS CO. LTD., Suwon-si (KR)

(72) Inventors: Hyunseok GIL, Overland Park, KS (US); Mohammed Nasir UDDIN, Overland Park, KS (US)

(73) Assignee: SAMSUNG ELECTRONICS CO. LTD., Suwon-si (KR)

(21) Appl. No.: 13/792,911

(22) Filed: Mar. 11, 2013

(51) Int. Cl. G10L 15/22

(52) U.S. Cl. CPC G10L 15/22
USPC 704/235; 704/275

(57) ABSTRACT

An apparatus and method for performing a function on a terminal according to a received audio command are provided. The method includes receiving an audio command, determining a command target based on the audio command, and performing a function associated with the command target.

### BACKGROUND OF THE INVENTION

1. Field of the Invention

The present invention relates to an apparatus and method for requesting a terminal to perform an action according to an audio command. More particularly, the present invention relates to an apparatus and method for requesting a terminal to perform an action according to an audio command using image processing.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

Many mobile terminals according to the related art have been equipped with voice recognition systems. Voice recognition systems are configured to enable a user to input commands or data by speaking within proximity of a microphone on the mobile terminal Mobile terminals according to the related art may be configured to store an application within which the data input via the voice recognition system is used. For example, an application may use the data as part of a dictation of a document in a word processing program. Mobile terminals according to the related art may be configured to store an application that responds to a command input via the voice recognition system. For example, an application may perform a function or execute a command according to the command input via the voice recognition system. In other words, the voice recognition system may recognize a certain word, phrase, sound or the like and the voice recognition system and/or the application may determine whether the word, phrase, sound or the like is associated with a predefined function or command. If the word, phrase, sound or the like is associated with a predefined function or command, then the application may execute the associated predefined function or command. An example of a predefined function or command that may be recognized via the voice recognition system and performed may include opening or initializing a camera application in response to the phrase “Open Camera,” and opening a text messaging application or sending a text message in response to the phrase “Send Text Message.”

Accordingly, there is a need for an apparatus and method for requesting a terminal to perform an action according to an audio command using image processing.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for a terminal to perform an action according to an audio command using image processing.

In accordance with an aspect of the present invention, a method for performing a function on a terminal according to a received audio command is provided. The method includes receiving an audio command, determining a command target based on the audio command; and performing a function associated with the command target.

In accordance with another aspect of the present invention, an apparatus for performing a function according to a received audio command is provided. The apparatus includes a display unit for displaying an image, an audio processing unit for receiving an audio command, and at least one controller for determining a command target based on the audio command, and for performing a function associated with the command target.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A to 1C are flowcharts illustrating a method of performing a command based on detected user input according to an exemplary embodiment of the present invention;

FIG. 2 is a diagram illustrating a number of occurrences of a requested command according to an exemplary embodiment of the present invention;

FIG. 3 is a diagram illustrating performance of a command based on detected used input according to an exemplary embodiment of the present invention; and

FIG. 4 is block diagram schematically illustrating a configuration of a mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for performing a function on a terminal according to a received audio command.

According to exemplary embodiments of the present invention, the terminal may parse the received audio command to identify a command action and a command target.

According to exemplary embodiments of the present invention, if the terminal determines that a screen displays a plurality of occurrences of the identified command target, then the terminal may highlight or otherwise emphasize the plurality of identified command targets for the user. According to exemplary embodiments of the present invention, the terminal may assign a unique number or other indicia to the plurality of command targets. For example, the terminal may assign a unique number or other indicia to each of the plurality of command targets to facilitate selection of the intended command target.

According to exemplary embodiments of the present invention, if the terminal determines that the displayed screen does not comprise any occurrences of the command target, then the terminal may provide a suggested command target corresponding to a command target that the mobile terminal determines the user may intend.

Exemplary embodiments of the present invention may receive an audio command, determine a command action and a command target according to the audio command, and perform a function associated with the command target according to a result of image processing on an image displayed by the terminal.

According to exemplary embodiments of the present invention, the terminal may correspond to a mobile terminal For purposes of describing exemplary embodiments of the present invention, the terminal is described as being a mobile terminal However, one of ordinary skill in the art would understand exemplary embodiments of the present invention as not being limited to a mobile terminal.

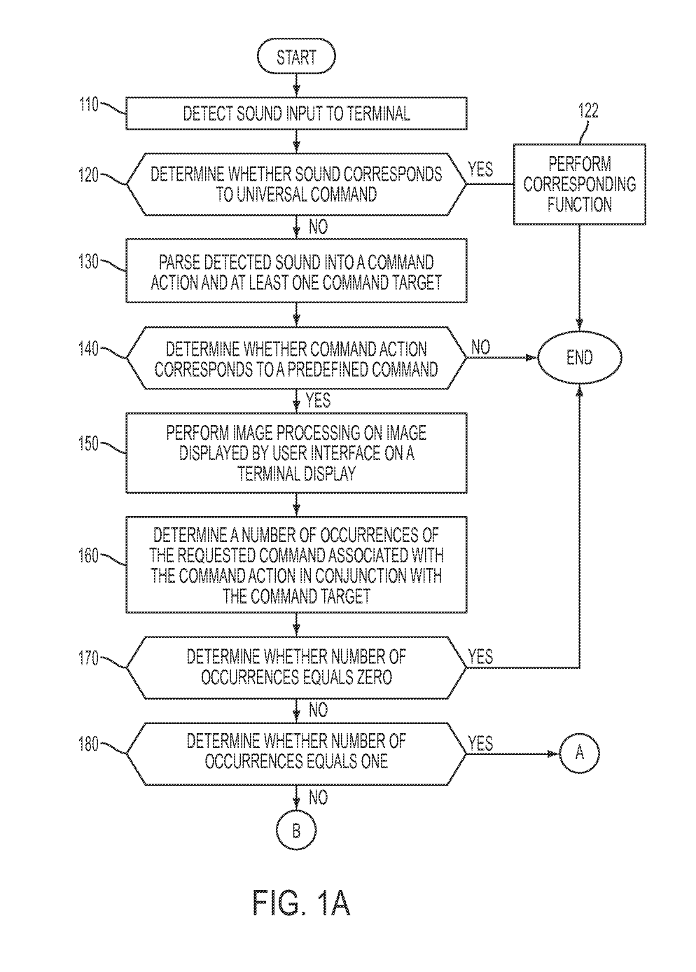

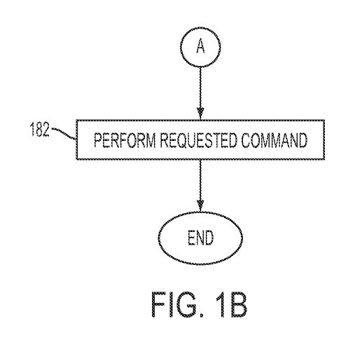

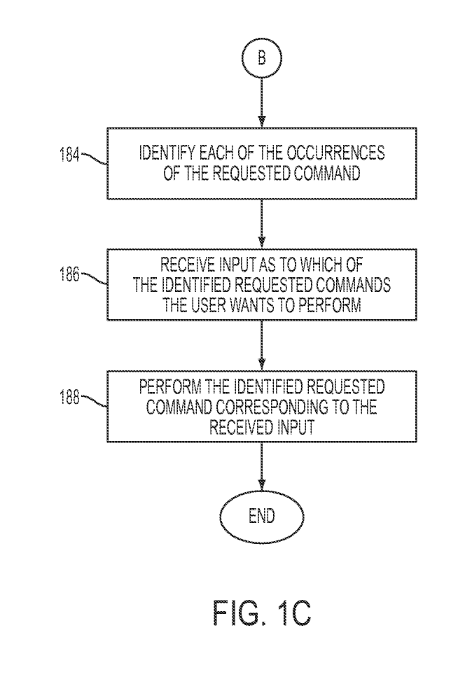

FIGS. 1A to 1C are flowcharts illustrating a method of performing a command based on detected user input according to an exemplary embodiment of the present invention.

Referring to FIGS. 1A to 1C, the mobile terminal detects a sound input thereto at step 110. For example, the mobile terminal may receive an audio command (e.g., a requested command) corresponding to a command for the mobile terminal to perform an action (e.g., a command, function, or the like). The mobile terminal may receive the requested command in response to a user pressing a key on an input terminal for indicating that the user wants to input an audio command.

At step 120, the mobile terminal determines whether the sound input thereto corresponds to a universal command. For example, the mobile terminal determines whether the audio command corresponds to a predefined command associated with a specific predefined function. Such universal commands may include a command to “Open Camera”, “Open Calendar”, and the like. In other words, according to an exemplary embodiment of the present invention, the receipt and performance of a universal command may require no further processing other than identifying that the audio command corresponds to a predefined command associated with a predefined function according to a predefined mapping of commands (e.g., words, phrases, and the like) with functions, and performing such a function.

If the mobile terminal determines that the sound input thereto corresponds to a universal command at step 120, then the mobile terminal proceeds to step 122 at which the mobile terminal performs the function corresponding to the universal command Thereafter, the mobile terminal ends the process.

Conversely, if the mobile terminal determines that the sound does not correspond to a universal command at step 120, then the mobile terminal proceeds to step 130 at which the mobile terminal parses the detected sound (e.g., the audio command corresponding to the requested command) into a command action and a command target. For example, if the audio command corresponds to the phrase “Click Next”, the mobile terminal parses the audio command into a command action corresponding to “Click” and a command target corresponding to “Next.” As another example, if the audio command corresponds to the phrase “Scroll Down”, the mobile terminal parses the audio command into a command action corresponding to “Scroll” and a command target corresponding to “Down.” According to exemplary embodiments of the present invention, the audio command may include a requested action and an associated word (e.g., “Click OK”, “Click Next”, “Scroll Down”). The audio command may also include a requested action (e.g., corresponding to the command action) and a series of words or a phrase (e.g., corresponding to the command target). For example, the audio command may be “Scroll Top to Bottom”. The mobile terminal parses the audio command such that the action “Scroll” corresponds to the command action and the series of words or the phrase “Top to Bottom” corresponds to the command target. As another example, if the audio command corresponds to “Highlight Apple to Orange” (e.g., drag/swipe apple to orange), then the mobile terminal parses the audio command such that the action “Highlight” corresponds to the command action and the series of words from “Apple” to “Orange” or the phrase “Apple to Orange” corresponds to the command target.

According to exemplary embodiments of the present invention, the command target may correspond to a word or text, or a predefined symbol such as, for example, a call symbol displayed on a dialer screen, a symbol on a keyboard, or the like.

According to exemplary embodiments of the present invention, the mobile terminal may parse the audio command into the command action and the command target based on at least one predefined action. For example, the mobile terminal may compare the audio command with a set of predefined actions comprising at least one predefined action. If the mobile terminal determines that the audio command comprises a command that corresponds to one of the predefined actions in the set of predefined actions, then the mobile terminal determines that such a predefined action corresponds to the command action. According to exemplary embodiments of the present invention, the set of predefined actions may include click, swipe, move, slide, press, drag, scroll, and the like.

At step 140, the mobile terminal determines whether the command action corresponds to a predefined command (e.g., a command stored in the set of predefined actions). According to exemplary embodiments of the present invention, the mobile terminal may determine whether the command action corresponds to a predefined command based on whether the audio command comprises a predefined command.

If the mobile terminal determines that the command action does not correspond to a predefined command at step 140, then the mobile terminal ends the process.

Conversely, if the mobile terminal determines that the command action corresponds to a predefined command at step 140, then the mobile terminal proceeds to step 150 at which the mobile terminal performs image processing on an image (e.g., an image displayed on the screen of the mobile terminal, an image displayed on the User Interface (UI), and the like).

According to exemplary embodiments of the present invention, the mobile terminal performs image processing on the image so as to identify text. The mobile terminal performs image processing on the image and identifies text in the image corresponding to the parsed command target. According to exemplary embodiments of the present invention, the mobile terminal may identify text in the processed image corresponding to the parsed command target using predefined language settings or configurations of the mobile terminal For example, if the mobile terminal is configured to use English as the default language, then the mobile terminal may analyze the processed image from left-to-right (and top-to-bottom) to determine whether any of the text in the processed image corresponds to the parsed command target. As another example, if the mobile terminal is configured to use Hebrew or Arabic as the default language, then the mobile terminal may analyze the processed image from right-to-left to determine whether any of the text in the processed image corresponds to the parsed command target.

According to exemplary embodiments of the present invention, the mobile terminal may identify the language used in the audio command and thereafter analyze the text in the processed image according to the identified language.

According to exemplary embodiments of the present invention, the mobile terminal may highlight the text in the processed image corresponding to (e.g., matching) the command target. The terminal may gray out (or remove) the remaining portion of the image. According to exemplary embodiments of the present invention, the text in the processed image corresponding to the command target may be accentuated (emphasized) relative to the remaining portion of the image or remaining portion of the text in the processed image.

At step 160, the mobile terminal determines a number of occurrences of the command target (e.g., the requested command associated with the command action). For example, after the mobile terminal has performed image processing on the image, the mobile terminal determines the number of instances of the command target comprised in the text of the processed image. For example, if the audio command corresponds to “Click Next,” then the mobile terminal determines the number of times the word “Next” appears in the text of the processed image.

At step 170, the mobile terminal determines whether the number of occurrences of the command target in the text of the processed image is equal to zero.

If the mobile terminal determines that the number of occurrences of the command target is zero at step 170, then the mobile terminal ends the process.

Conversely, if the mobile terminal determines that the number of occurrences of the command target is not zero at step 170, then the mobile proceeds to step 180.

At step 180, the mobile terminal determines whether the number of occurrences of the command target in the text of the processed image is equal to one.

If the mobile terminal determines that the number of occurrences of the command target is equal to one at step 180, then the mobile terminal proceeds to A and to step 182 of FIG. 1B, at which the mobile terminal performs the requested command. For example, if the requested command corresponds to “Click Next” and “Next” appears in the text of the processed image once, then the mobile terminal performs a function associated with “Click Next.” For example, the mobile terminal may generate a touch event on the coordinate of the text corresponding to “Next” such that “Next” is clicked. As another example, if the requested command corresponds to “Swipe Apple to Orange” and the text in the processed image only includes one occurrence of the word Apple preceding the word Orange, then the mobile terminal may generate a touch event so as to swipe from the word Apple to the word Orange (e.g., so as to highlight all portions of the image between the word Apple and the word Orange). Thereafter, the mobile terminal ends the process.

In contrast, if the mobile terminal determines that the number of occurrences of the command target is not equal to one at step 180, then the mobile terminal proceeds to B and to step 184 of FIG. 1C. At step 184, the mobile terminal may identify each of the occurrences of the command target corresponding to the requested command. For example, the mobile terminal may highlight the text in the processed image corresponding to the command target. As another example, the mobile terminal may gray out the portions of the processed image that do not correspond to the command target.

According to exemplary embodiments of the present invention, the mobile terminal may assign a unique number or other indicia to each of the occurrences of the command target. According to exemplary embodiments of the present invention, the mobile terminal may assign a unique number or other indicia according to an order of occurrence. An order of occurrence may be determined using an analysis of the processed image from left-to-right, from top-to-bottom, and the like. For example, the order of occurrence may be determined according to a user's native language, or a default language of the mobile terminal If the mobile terminal has a default language setting of English, the order of occurrence may be determined based on the order of occurrence appearing from left to right (and from top-to-bottom).

At step 186, the mobile terminal receives input as to which of the identified requested commands (e.g., the identified occurrences of the command target) that the user wants to perform. According to exemplary embodiments of the present invention, upon determination that the processed image includes a plurality of occurrences of the command target, the mobile terminal may prompt the user to select which of the occurrences of the command target corresponds to the requested command that the user wants the mobile terminal to perform. The input as to which of the requested commands the user wants the mobile terminal to perform may be via an audio command or via selection of the occurrence of the command target through selection on a touch screen or the like.

At step 188, the mobile terminal performs the identified requested command corresponding to the received input. For example, upon confirmation as to which of the occurrences of the command targets on the processed image that the user wants the mobile terminal to perform, the mobile terminal performs the corresponding command (e.g., the mobile terminal performs the function associated with the command)

According to exemplary embodiments of the present invention, any of the steps described in relation to FIG. 1 may be omitted or combined with another step. For example, steps 160, 170, and 180 may be combined into a single conditional step.

According to exemplary embodiments of the present invention, steps 120 and 122 may be omitted from the method of performing a command based on detected user input.

According to exemplary embodiments of the present invention, the mobile terminal may provide the user with voice hints. For example, after step 184, the mobile terminal may provide the user with an audio indication as to the number of occurrences of the command target. As another example, the mobile terminal may provide the user with suggested command targets such as identifying buttons or links that are displayed on the screen.

According to exemplary embodiments of the present invention, if the mobile terminal does not recognize the sound input thereto (e.g., if the mobile terminal does not recognize the audio command), then the mobile terminal may alert the user. For example, if the mobile terminal does not recognize the audio command, or if the mobile terminal does not recognize at least one of the command action and the command target, then the mobile terminal may indicate to the user that the command is not recognized. The mobile terminal may request clarification or re-submission of the audio command. As an example, such an indication may be performed after step 120 and/or step 140.

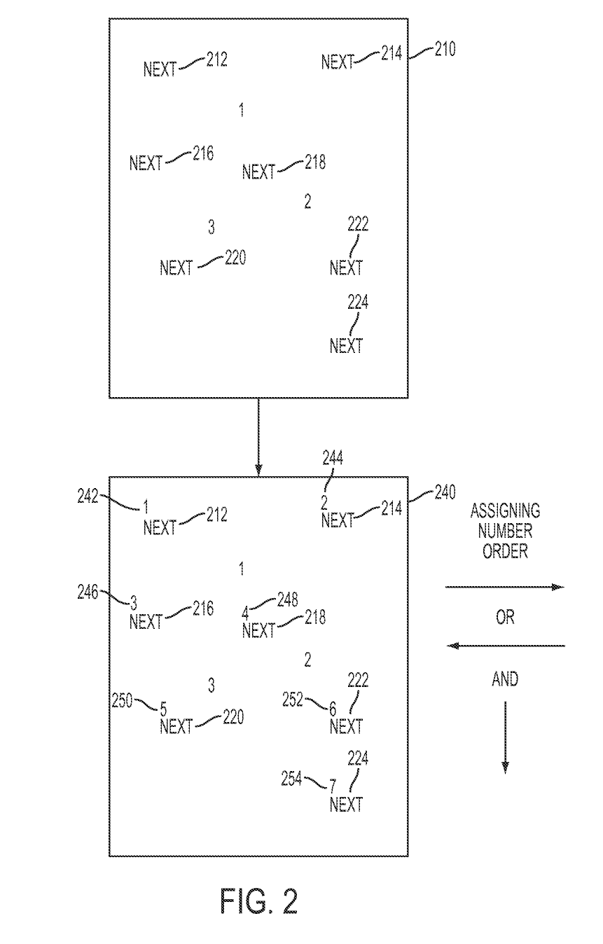

FIG. 2 is a diagram illustrating a number of occurrences of a requested command according to an exemplary embodiment of the present invention.

Referring to FIG. 2, image 210 illustrates the image post image processing. For example, the mobile terminal has performed image processing and recognized the text of the processed image. The image 210 includes a plurality of occurrences of the word “Next” identified by reference numerals 212, 214, 216, 218, 220, 222, and 224.

According to exemplary embodiments of the present invention, the mobile terminal may assign a unique number or indicia to each of occurrences of the command target. If the command target corresponds to “Next”, then the mobile terminal may assign a unique number to each occurrence of “Next.” The mobile terminal may assign a unique number to each occurrence of the command target when the processed image includes a plurality of occurrences of the command target.

Image 240 illustrates the image post image processing in which each of the occurrences “Next” has been assigned a corresponding unique number. For example, “Next” 212 has a “1” that is denoted by reference numeral 242 assigned thereto. “Next” 214 has a “2” that is denoted by reference numeral 244 assigned thereto. “Next” 216 has a “3” that is denoted by reference numeral 246 assigned thereto. “Next” 218 has a “4” that is denoted by reference numeral 248 assigned thereto. “Next” 220 has a “5” that is denoted by reference numeral 250 assigned thereto. “Next” 222 has a “6” that is denoted by reference numeral 252 assigned thereto. “Next” 224 has a “7” that is denoted by reference numeral 254 assigned thereto.

According to exemplary embodiments of the present invention, each of the occurrences of the command target may be highlighted in contrast to the remaining portion the processed image. For example, in contrast to image 210, image 240 illustrates each occurrence of “Next” as being highlighted and the remaining portion of the processed image being grayed out. According to exemplary embodiments of the present invention, the non-highlighted portions (e.g., the remaining portion) is ignored.

According to exemplary embodiments of the present invention, the mobile terminal may be configured to assign the unique number or indicia to each occurrence of the command target according to a predefined method. For example, as illustrated in image 240, the unique numbers denoted by reference numeral 242 to 254 are assigned from left-to-right and from top-to-bottom. According to exemplary embodiments of the present invention, the method for assigning unique numbers or indicia to each occurrence of the command target may be defined according to a native language of the user of the mobile terminal

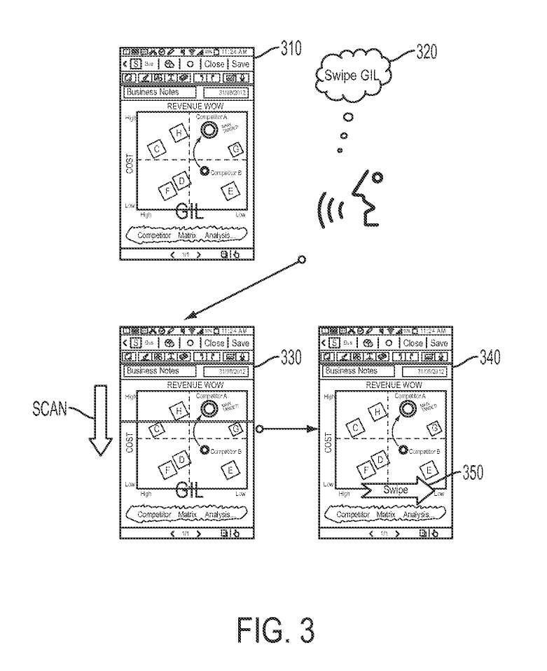

FIG. 3 is a diagram illustrating performance of a command based on detected used input according to an exemplary embodiment of the present invention.

Referring to FIG. 3, the mobile terminal displays an image 310 on the screen (or UI). The user inputs an audio input 320 corresponding to an audio command. The audio command corresponds to “Swipe GIL.” The command action corresponds to “Swipe” and the command target corresponds to “GIL.”

Thereafter, the mobile terminal performs image processing on the image 310 and the mobile terminal scans the processed image 330 for text corresponding to the command target “GIL.” As illustrated in the processed image 330, the command target occurs once.

According to exemplary embodiments of the present invention, the mobile terminal determines that the command target “GIL” occurs once in the image 340 and performs the requested command by generating a swipe event 350 on the command target “GIL.”

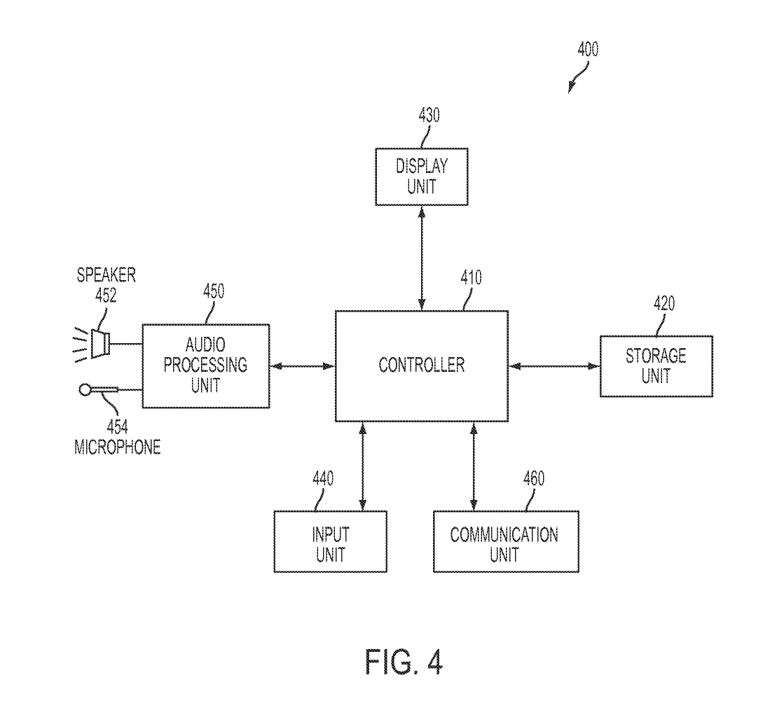

FIG. 4 is block diagram schematically illustrating a configuration of a mobile terminal according to an exemplary embodiment of the present invention.

Referring to FIG. 4, the mobile terminal 400 includes a controller 410, a storage unit 420, a display unit 430, an input unit 440, and an audio processing unit 450. According to exemplary embodiments of the present invention, the mobile terminal 400 may also include a communication unit 460.

According to exemplary embodiments of the present invention, the mobile terminal 400 may be configured to perform an action (e.g., a command, function, or the like) according to an audio command.

According to exemplary embodiments of the present invention, the mobile terminal 400 may be configured to receive an audio input (e.g., an audio command), perform image processing on an image (e.g., a screen) displayed by the display unit 430, identify a target associated with the audio command, and perform an action (e.g., a command, function, or the like) according to the audio command.

According to exemplary embodiments of the present invention, the mobile terminal 400 may be configured to receive an audio input (e.g., an audio command), perform image processing on an image (e.g., a screen, an image of the User Interface (UI), and the like) displayed by the display unit 430, identify a target associated with the audio command, receive confirmation as to which of a plurality of occurrences of the requested command to perform, and perform an action (e.g., a command, function, or the like) according to the audio command on the confirmed occurrence of the plurality of occurrences of the requested command.

According to exemplary embodiments of the present invention, the mobile terminal comprises at least one controller 410. The at least one controller 410 may be configured to operatively control the mobile terminal 400. For example, the controller 410 may control operation of the various components or units included in the mobile terminal 400. The controller 410 may transmit a signal to the various components included in the mobile terminal 400 and control a signal flow between internal blocks of the mobile terminal 400. In particular, the controller 410 according to exemplary embodiments of the present invention may perform an action (e.g., a command, function, or the like) according to an audio command. For example, the controller 410 may perform video processing on an image on the screen and determine whether the image on the screen includes any target commands corresponding to the requested command. The controller 410 may execute the target command corresponding to the requested command. As an example, if a multiple target commands occur (e.g., if a plurality of target commands exist) on the image of the screen, then the controller 410 may identify the target commands and prompt the user to confirm to which of the plurality of target commands the requested command corresponds. According to exemplary embodiments of the present invention, the controller 410 may include or be operatively connected to an image processing unit that performs various image processing on an image such as the image displayed on the screen. The image processing unit may process the image to identify target commands corresponding to the requested command

The storage unit 420 can store user data, and the like, as well a program which performs operating functions according to an exemplary embodiment of the present invention. The storage unit may include a non-transitory computer-readable storage medium. As an example, the storage unit 420 may store a program for controlling general operation of a mobile terminal 400, an Operating System (OS) which boots the mobile terminal 400, and application program for performing other optional functions such as a camera function, a sound replay function, an image or video replay function, a signal strength measurement function, a route generation function, image processing, and the like. Further, the storage unit 420 may store user data generated according to a user of the mobile terminal, such as, for example, a text message, a game file, a music file, a movie file, and the like. In particular, the storage unit 420 according to exemplary embodiments of the present invention may store an application or a plurality of applications that individually or in combination receive an audio input, recognize an audio command corresponding to the requested command from the audio input, operatively perform image processing of an image on the screen, determine whether the image on the screen includes any target commands correspond to the requested command, and perform the requested command using an identified target command. For example, the storage unit 420 may store an application that performs video processing on an image on the screen to determine whether the image on the screen includes any target commands correspond to the requested command, identifies any target command corresponding to the requested command, assigns a unique identification to each of the identified target commands (e.g., if there is more than one identified target command), request confirmation as to which of the identified target commands corresponds to the requested command (e.g., which of the identified target commands the user desires the mobile terminal to perform), and perform the confirmed target command corresponding to the requested command (e.g., the target command confirmed by the user).

The display unit 430 displays information inputted by user or information to be provided to user as well as various menus of the mobile terminal 400. For example, the display unit 430 may provide various screens according to a user of the mobile terminal 400, such as an idle screen, a message writing screen, a calling screen, and the like. In particular, the display unit 430 according to exemplary embodiments of the present invention may display an image and/or UI from which the user may select a command. For example, based on the image displayed on the screen, the user may input a command (e.g., an audio command). Upon receiving the requested command, the display unit 430 may display a video processed image in which a plurality of target commands corresponding to the requested command are displayed. For example, the display unit 430 may display a video processed image which highlights or filters the image on the screen so as to identify the plurality of target commands The display unit 430 may display a video processed image in which each of the plurality of target commands are identified with a unique number or indicia. For example, the display unit 430 may display an interface which the user may manipulate or otherwise enter inputs via a touch screen to enter selection of the function relating to the signal strength of the mobile terminal 400. The display unit 430 can be formed as a Liquid Crystal Display (LCD), an Organic Light Emitting Diode (OLED), an Active Matrix Organic Light Emitting Diode (AMOLED), and the like. However, exemplary embodiments of the present invention are not limited to these examples. Further, the display unit 430 can perform the function of the input unit 440 if the display unit 430 is formed as a touch screen.

The input unit 440 may include input keys and function keys for receiving user input. For example, the input unit 440 may include input keys and function keys for receiving an input of numbers or various sets of letter information, setting various functions, and controlling functions of the mobile terminal 400. For example, the input unit 440 may include a calling key for requesting a voice call, a video call request key for requesting a video call, a termination key for requesting termination of a voice call or a video call, a volume key for adjusting output volume of an audio signal, a direction key, and the like. In particular, the input unit 440 according to exemplary embodiments of the present invention may transmit to the controller 410 signals related to selection or setting of functions relating to the input of a command. For example, the input unit 440 may include a key for receiving an indication that the user requests to input an audio command. Such a key may be a key specifically assigned the function of allowing a user to request to input an audio command. Alternatively, the key for allowing a user to request to input an audio command may be assigned based on the application being executed at any given time. Upon pressing the key for receiving an indication that the user request to input an audio command, the user may speak into a microphone operatively connected to the mobile terminal 400. Such an input unit 440 may be formed by one or a combination of input means such as a touch pad, a touchscreen, a button-type key pad, a joystick, a wheel key, and the like.

The audio processing unit 450 may be formed as an acoustic component. The audio processing unit 450 transmits and receives audio signals, and encodes and decodes the audio signals. For example, the audio processing unit 450 may include a CODEC and an audio amplifier. The audio processing unit 450 is connected to a Speaker (SPK) 452 and a Microphone (MIC) 454. The audio processing unit 450 converts analog voice signals inputted from the MIC into digital voice signals, generates corresponding data for the digital voice signals, and transmits the data to the controller 410. Further, the audio processing unit 450 converts digital voice signals inputted from the controller 410 into analog voice signals, and outputs the analog voice signals through the SPK 452. Further, the audio processing unit 450 may output various audio signals generated in the mobile terminal 400 through the SPK 452. For example, the audio processing unit 450 can output audio signals according to an audio file (e.g., MP3 file) replay, a moving picture file replay, and the like through the SPK. In particular, according to exemplary embodiments of the present invention, the audio processing unit 450 may receive an audio input (e.g., an audio command corresponding to a requested command from the user) through the MIC 454. According to exemplary embodiments of the present invention, the audio processing unit 450 may be operatively coupled to another input unit through which audio signals may be input. For example, the audio processing unit 450 may be operatively coupled to a Bluetooth accessory (e.g., a Bluetooth headset, a Bluetooth microphone) and the like.

The communication unit 460 may be configured for communicating with other devices. For example, the communication unit 460 may be configured to communicate via Bluetooth technology, WiFi technology, or another wireless technology.

As a non-exhaustive illustration only, a terminal described herein may refer to mobile devices such as a cellular phone, a Personal Digital Assistant (PDA), a digital camera, a portable game console, and an MP3 player, a Portable/Personal Multimedia Player (PMP), a handheld e-book, a portable lap-top PC, a tablet PC, a Global Positioning System (GPS) navigation, and devices such as a desktop PC, a High Definition TeleVision (HDTV), an optical disc player, a setup box, a car navigation unit, a medical device, and the like which may be capable of wireless communication or network communication consistent with that disclosed herein. A terminal may also include an embedded system and/or device capable of receiving audio commands.

Program instructions to perform a method described herein, or one or more operations thereof, may be recorded, stored, or fixed in one or more non-transitory computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as Read-Only Memory (ROM), Random Access Memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more non-transitory computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for performing a function on a terminal according to a received audio command, the method comprising:
receiving an audio command;
determining a command target based on the audio command; and
performing a function associated with the command target.

2. The method of claim 1, further comprising:
performing image processing on an image displayed by the terminal; and
determining whether text corresponding to the command target occurs in the processed image.

3. The method of claim 2, further comprising:
identifying an occurrence of the command target in the processed image.

4. The method of claim 3, wherein the identifying of the occurrence of the command target in the processed image comprises:
displaying the processed image such that the occurrence of the command target is emphasized relative to a remaining portion of the processed image.

5. The method of claim 3, wherein the identifying of the occurrence of the command target in the processed image comprises:
determining whether the processed image includes a plurality of occurrences of the command target; and
if the processed image includes a plurality of occurrences of the command target, assigning a unique indicator to each of the plurality of occurrences of the command target.

6. The method of claim 5, wherein the identifying of the occurrence of the command target in the processed image further comprises:
displaying the processed image such that each of the plurality of occurrences of the command target and associated unique indicator is emphasized relative to a remaining portion of the processed image.

7. The method of claim 5, wherein the assigning of the unique indicator to each of the plurality of occurrence so the command target comprises:
assigning the unique indicator to each of the plurality of occurrences according to a predefined language setting of the terminal.

8. The method of claim 5, wherein the unique indicator corresponds to a number.

9. The method of claim 2, further comprising:
parsing the audio command for a command action and the command target.

10. The method of claim 9, further comprising:
determining whether the command action corresponds to a predefined action.

11. The method of claim 1, wherein the performing of the function associated with the command target comprises:
generating an event in relation to the command target according to the audio command.

12. A terminal for performing a function according to a received audio command, the apparatus comprising:
a display unit for displaying an image;
an audio processing unit for receiving an audio command; and
at least one controller for determining a command target based on the audio command, and for performing a function associated with the command target.

13. The terminal of claim 12, wherein the controller is configured to perform image processing on an image displayed by the terminal, and to determine whether text corresponding to the command target occurs in the processed image.

14. The terminal of claim 13, wherein the controller is further configured to identify an occurrence of the command target in the processed image.

15. The terminal of claim 14, wherein the controller is further configured to control the display unit to display the processed image such that the occurrence of the command target is emphasized relative to a remaining portion of the processed image.

16. The terminal of claim 14, wherein the controller is further configured to determine whether the processed image includes a plurality of occurrences of the command target, and to assign a unique indicator to each of the plurality of occurrences of the command target if the processed image includes a plurality of occurrences of the command target.

17. The terminal of claim 16, wherein the controller is further configured to control the display unit to display the processed image such that each of the plurality of occurrences of the command target and associated unique indicator is emphasized relative to a remaining portion of the processed image.

18. The terminal of claim 16, wherein the controller is further configured to assign the unique indicator to each of the plurality of occurrences according to a predefined language setting of the terminal

19. The terminal of claim 16, wherein the unique indicator corresponds to a number.

20. The terminal of claim 13, wherein the controller is further configured to parse the audio command for a command action and the command target.

21. The terminal of claim 20, wherein the controller is further configured to determine whether the command action corresponds to a predefined action.

22. The terminal of claim 12, wherein the controller is configured to generate an event in relation to the command target according to the audio command.
